(19) United States
(12) Patent Application Publication
(10) Pub. No.: US 2017/0220995 A1
(43) Pub. Date: Aug. 3, 2017

(54) System for Recording an Inventory of Monitoring Objects of a Plant

(71) Applicant: AVL LIST GMBH, GRAZ (AT)

(72) Inventors: MICHAEL PAULWEBER, HAUSMANNSTÄTTEN (AT); PETER PRILLER, GRATWEIN-STRASSENGEL (AT)

(73) Assignee: AVL LIST GMBH, GRAZ (AT)

(21) Appl. No.: 15/500,602

(22) PCT Filed: Jul. 31, 2015
(86) PCT No.: PCT/EP2015/067636

§ 371 Date: Jan. 31, 2017

(30) Foreign Application Priority Data
Jul. 31, 2014 (AT) A 50542/2014

(51) Int. Cl. G06Q 10/08; G06K 7/10

(52) U.S. Cl. CPC G06Q 10/087; G06K 7/10297; H04B 5/0062

(57) ABSTRACT

Systems and methods for recording an inventory of monitoring objects (1) of a plant (4) having a multiplicity of fixed or non-fixed areas (5) where monitoring objects (1) can be located. The plant (4) is suitable for carrying out sequences of operations using the monitoring objects (1) and has a multiplicity of detection devices (6) which are each assigned to an area (5) of the plant (4). The monitoring objects (1) are in each case provided with preferably contactlessly readable identification elements (3), which have a unique identifier. The detection devices (6) have a data connection to an arithmetic unit (7), which manages an inventory database (8).

In a first aspect, the present invention relates to a system for recording an inventory of monitoring objects of a plant having a multiplicity of fixed or non-fixed areas where monitoring objects can be located, wherein the plant is suitable for carrying out sequences of operations using the monitoring objects.

In a second aspect, the invention relates to a method for mapping an inventory of monitoring objects of a plant in an inventory database, wherein the plant has a multiplicity of detection devices which are each associated with an area of the plant, and wherein the monitoring objects have identifying elements which can be read, preferably contactlessly, by the detection devices.

Finally, in a third aspect, the invention also relates to a bridging device for a housing of an object group, which has a plurality of monitoring objects, which are each provided with contactlessly readable identification elements (RFID tag) which have a unique identifier, wherein the housing has a shielding effect.

Numerous solutions for tracking moving or non-fixed objects have been developed, wherein GPS-based solutions in particular, or tracking systems based on RFID, are used for tracking vehicles or mobile devices, for example. Tracking systems based on satellite navigation, in particular GPS, have the disadvantage that they are not suitable for systems inside buildings as the satellite connection is disrupted therein. RFID systems are used in particular for warehouses for automated warehouse management, wherein all goods in the warehouse are fitted with an RFID tag which is scanned either with a hand scanner or with a permanently installed scanner when goods are deposited in or retrieved from the store, thus enabling a storage movement to be automatically recognized and entered into the system.

US2010/0156597 A1 discloses such an inventory system for products fitted with an RFID tag in a business or warehouse where the stock is recorded with the help of RFID readers.

US 2004/0024644 A1 discloses an RFID-supported monitoring system for goods in a logistics process.

The systems of the prior art are only poorly suited to the automatic monitoring of monitoring objects in dynamically changing environments, such as those which prevail in test environments, for example, such as engine test rigs, for instance. One reason for this is that the known systems provide no hierarchical classification of the monitored objects. Although, with existing systems, it is possible to determine whether a particular item (that is to say a monitoring object identified by means of an RFID tag) is currently located in the system, only limited conclusions can be drawn relating to the exact position, and it is not known whether the item is combined with other items to form a functional group. Therefore, it is also impossible to know, based on an automatically managed database, whether, for example, a test run planned for a test system can be carried out with the monitoring objects currently fitted.

The present invention is therefore based on the object of providing devices and methods which considerably simplify the planning, feasibility study and implementation of dynamic and changing plants and, in particular, to simplify the planning and implementation of tests (e.g. test runs) on test rigs.

According to the invention, in a first aspect of the invention, these objectives are achieved with a system mentioned in the introduction in which the plant has a multiplicity of detection devices which are each assigned to an area of the plant, wherein the monitoring objects are in each case provided with preferably contactlessly readable identification elements which have a unique identifier, wherein the detection devices have a data connection to an arithmetic unit which manages an inventory database. This system enables automatic management and monitoring of the monitoring objects of a plant, wherein the status of the plant, i.e. the particular configuration, can also be determined at any time.

In conjunction with the present description, the totality of the elements and features which are involved in the implementation of the tasks associated with the plant, such as in particular the monitoring objects in the different areas, that is to say, for example, a test rig including all components required for carrying out a test run, such as, for example, the equipment under test, the dynamometer, the operating materials (in particular the fuel), the measuring sensors, etc., is referred to as “plant.”

In conjunction with the present description, the totality of the elements and features which are involved in the recording according to the invention of the inventory of monitoring elements of the plant, is referred to as “system.” The system therefore comprises the elements and features of the plant in general as well as all further elements and features which are required for implementing the invention, such as in particular the detection devices, the identification elements and the inventory database.

In conjunction with this description, all objects present in the plant which are provided with a readable identification element, in particular an RFID tag, which carries a unique identifier, are referred to as “monitoring objects.” According to the invention, particular attention is paid to monitoring objects which are part of the plant and therefore not objects which are machined and/or processed by the plant. Monitoring objects can, in particular, be devices (e.g. measuring instruments, transport devices, objects to be tested, etc.) or (raw) materials which are used or consumed in the plant. (As many consumables cannot themselves be provided with an RFID tag, in particular the containers for consumables, e.g. refillable containers such as, for example, cartridges for lubricants, toner containers, tanks or similar, can be defined as monitoring objects). For test environments, the respective arrangement and combination of installed measuring instruments in particular is of special interest.

In conjunction with the present description, spatially limited locations in which objects can be located are referred to as “areas.” For example, without being restricted thereto, a certain room, work area or machine can be defined as an area. In an advantageous manner, the detection of the monitoring objects also allows a conclusion to be drawn as to whether the appropriate monitoring object is located in a suitable position for use, e.g. whether a measuring sensor is fitted in the mounting provided for the purpose.

In conjunction with the present description, an object which can be preferably contactlessly localized by a detection device, e.g. an RFID label, is referred to as an “identification element,” wherein the object has a readable, unique identifier, in particular a code, which enables a unique assignment to a particular monitoring object. The code can be assigned to a serial number of the object, for example. Depending on expediency, identification elements which can be read in a tactile manner (e.g. in the form of a chip card) or optical manner (for example in the form of a barcode) or a combination of different identification elements can be used.

The sequence of operations carried out by the plant can, in particular, be a production process or a test process. Particularly in test environments, it is important to have an up-to-date overview of the measuring instruments present in the test rig at all times (e.g. for flow, emissions, particle counting, power, etc.). In general, the monitoring objects are actively involved in the implementation of the sequences of operations, for example in the implementation of a test run or in the determination and/or evaluation of the measurements. In contrast, there can also be objects which are items to be modified and machined or processed by the sequence of operations, or are a product of the sequence of operations. Although such objects can also basically be defined as monitoring objects as long as they are provided with an identification object, in many sequences of operations, in particular in test runs on engine test rigs, there are no such objects as no machining or processing of objects takes place. Many objectives according to the invention relate in particular to sequences of operations which are not production processes and in which no objects are machined or processed.

In a preferred embodiment, the plant can have at least one detection device or a group of detection devices which is/are suitable for determining position. By this means, not only the presence but also a current position of monitoring objects can be detected in order to be able to also locate and, if necessary, replace the respective devices during operation with the help of the system. In general, objects, which are required, for example, for a measuring task, such as a measuring shaft, certain hose connections, adapters for mechanical connectors, actuators, such as for example accelerator pedal actuators, etc., can be marked and inventoried in this way.

In an advantageous manner, the system according to the invention can have a multiplicity of object groups which can comprise one or more monitoring objects. This enables the formation of complex functional units which can in each case be detected in totality or based on individual objects included.

In conjunction with the present description, a monitored, possibly non-fixed unit, which comprises a plurality of monitoring objects, is referred to as an “object group.” Particular functionalities, which can depend on the status of the monitoring objects present in the object group and/or on the location of the object group, can be associated with an object group. For example, measuring instruments which consist of parts or sub-systems, e.g. sample extraction, sample preparation, measuring sensor, evaluation electronics or similar, can be defined as an object group. Such parts, or also modules, can also be replaced individually if necessary. By monitoring the object groups, it can be ensured that a consistent set of approved parts is used at all times.

In a preferred embodiment of the system according to the invention, the arithmetic unit can have means for checking whether a given sequence of operations of the plant can be implemented with the existing monitoring objects or object groups. This creates the possibility of checking the integrity of object groups and anticipatory planning of resources.

In conjunction with the present description, a method in which it is checked whether an object group contains all monitoring objects which are required for implementing a particular task, possibly whether all object groups or monitoring objects are present and/or are located in a given area, possibly whether an object group or monitoring objects located therein are suitable for use or require maintenance, and possibly whether certain or all monitoring objects and/or object groups are original products, is referred to as an “integrity check.” This also allows fake products to be detected.

In an advantageous manner, the plant can be part of an intelligent manufacturing line and the sequence of operations can be a production process. This enables anticipatory simulation and planning of set-up times, production sequences and service activities. An arrangement of machines, raw materials and control devices, which enables the plant to be automatically adapted to suit different production sequences, is referred to as an “intelligent manufacturing line.”

In a further advantageous embodiment of the system according to the invention, the plant can be part of a test environment and the sequence of operations can serve to implement a test, an experiment and/or a measuring process. This enables the preparation and set-up time for implementing a test run to be minimized.

A plant, which has at least one test rig and, in general, a multiplicity of measuring instruments, is referred to as a “test environment.” The test line can also have an integral simulation environment, e.g. for implementing an HiL simulation. In general, the sequence of operations implemented by a test environment, in which a plant located on the test rig is operated under certain specified parameters, serves to implement different measurements.

In the second aspect of the present invention, the objectives according to the invention are achieved by a method mentioned in the introduction which has the following steps: reading out by means of a detection device assigned to an area of at least one unique identifier from at least one contactlessly readable identification element which is present in the appropriate area; determination of a particular monitoring object to which the identifier read from the identification element is assigned; determination of data which relate to the monitoring object; and storage or updating of the data in the inventory database. With this method, a current representation of the monitoring objects actually present in the plant can be automatically guaranteed. At the same time, the monitoring objects can be spatially assigned to each area. Monitoring the feasibility of certain tests enables the planning, for example, of which tests (e.g. test runs) can be carried out on which test rigs at particular times (scheduling). At the same time, it can also be determined which measuring instruments are required for the purpose. Detecting the devices present on the test rig now enables an automatic display of whether these tasks can be carried out as planned. Further, a warning can automatically be generated when, for example, a device which will soon be required has been inadvertently removed from a test rig by the operating personnel.

In an advantageous manner, the method can also have the following steps: determination of an object group to which a particular monitoring object is assigned; determination of data which relate to the object group; and storage or updating of the data in the inventory database. Identifying a plurality of parts of a device (e.g. measuring sensor, conditioning unit, signal processing, operator panel) with an RFID tag in each case enables not only the simple presence of the overall system (=device) to be checked from the combination but also its consistency, i.e., for example, it can be detected whether a certain part, for example a conditioning unit, has been changed since the last detection (and therefore a different ID is reported by the RFID tag). This can be used for automatic reporting of maintenance activities, conversions and possibly the presence of fake products that have apparently taken place earlier.

In an advantageous manner, the read-out can be initiated at controlled intervals and/or on the occurrence of an event. This enables both ongoing monitoring (e.g. to detect when a monitoring object enters or leaves an area) as well as the recording of an overall picture at a particular instant in time.

Furthermore, in an advantageous manner, the method according to the invention can have the step of checking the integrity of a monitoring object and/or an object group. This enables the completeness and the readiness-for-use of the plant to be interrogated.

Further, in an advantageous manner, it can be checked whether a planned activity with the plant can be carried out with the monitoring objects or object groups present in the plant. If necessary, a warning can also be output. This enables configuration errors to be avoided in good time.

In an advantageous embodiment of the invention, data from the database can be transmitted to a service provider remote from the plant. This enables remote monitoring and maintenance planning by a service provider, e.g. by the manufacturer of the plant. In doing so, the proprietor can determine which data are to be transmitted to the service provider and which are not (e.g. only consistency data). This enables central inventory management to be provided.

The bridging device mentioned in the introduction according to the third aspect of the invention has an internal antenna, an external antenna and a gateway which enable identification elements arranged in the housing to be detected via the external antenna. Other monitoring objects which are arranged in a shielded housing of an object group can also be detected by the detection devices of a plant with the help of this device by scanning the external antenna.

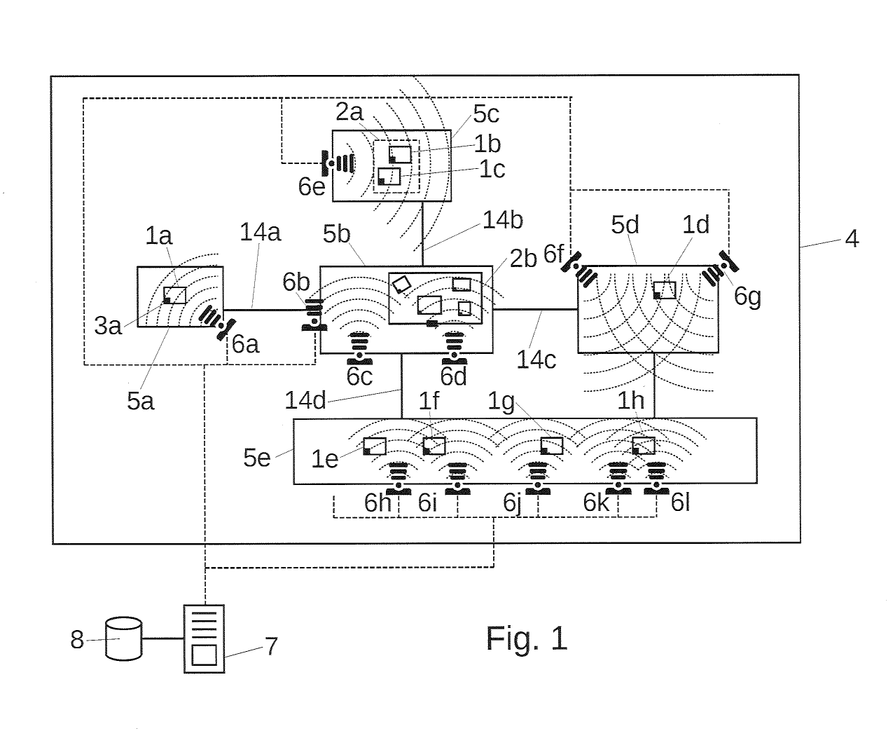

The present invention is explained in more detail below with reference to FIGS. 1 to 3, which show advantageous embodiments of the invention in an exemplary, schematic and non-restricting form. In the drawing

FIG. 1 shows a schematic diagram of a plant which is provided with the system according to the invention;

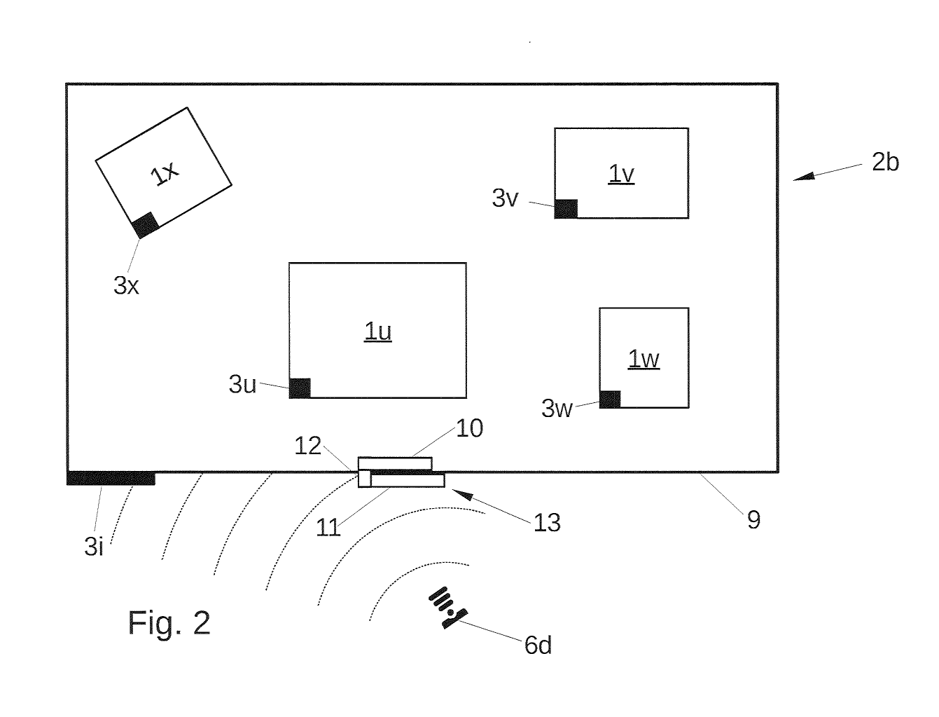

FIG. 2 shows a schematic diagram of an object group in a housing which is provided with the bridging device according to the invention; and

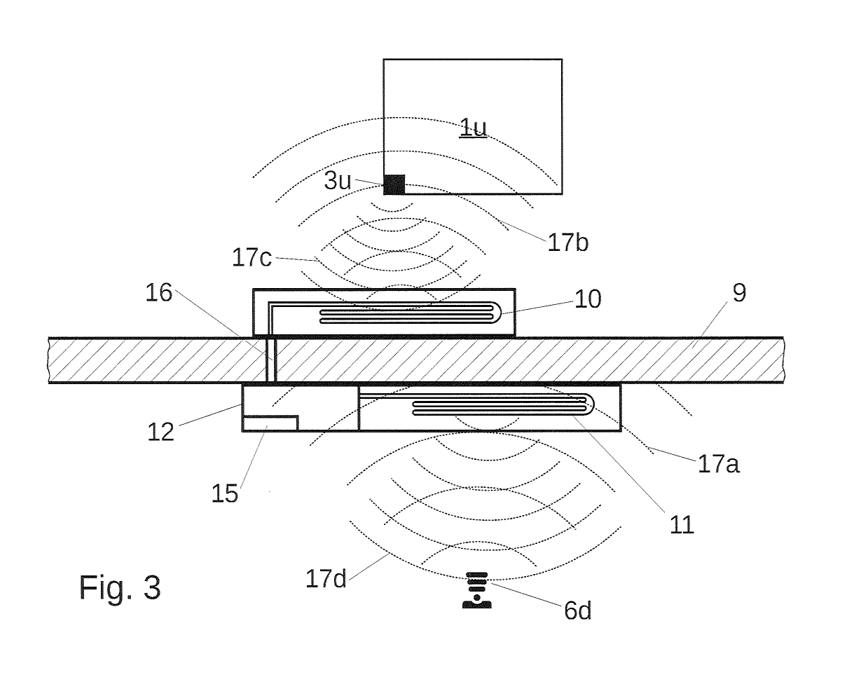

FIG. 3 shows a schematic diagram of the bridging device.

The references of objects which occur several times in the figures are supplemented by lowercase letters to enable differentiation.

In a schematic diagram, FIG. 1 shows a plant 4 which is divided into five areas 5a-5e. These areas represent different spatially limited parts of the plant, for example machining centers, transport devices, storage areas, test rigs, etc. A multiplicity of different monitoring objects 1a-1h can be located in each area, wherein each monitoring object is provided with an identification element. (In FIG. 1, only the identification element 3a of the monitoring object 1a is provided with a reference for reasons of clarity.) Each identification element has a unique identifier which can be read by appropriate detection devices 6a-6l. Reading can preferably be carried out contactlessly, for example the identification element 3a can be an RFID tag and the detection device 6a can be an RFID scanner which detects the RFID tag in the appropriate area 5a and reads its identifier. The connections 14a-14e between the areas 5a-5e represent transport paths on which the monitoring objects 1 can pass from one area to another.

The areas can each have a plurality of detection devices 6a-6l. For example, five detection devices 6h, 6i, 6j, 6k, and 6l are arranged parallel to one another along the area 5e and each scan a certain part of the area 5e. The area 5e could represent a conveyor device or a production or test line, for example, wherein the position in which monitoring objects 1e to 1h present in the area 5e are currently located can be determined by the detection devices 6h to 6l. In the case of conveyor devices, the monitoring objects could be transport containers for example. On the other hand, the elongated area 5e could be a long workbench or laboratory bench on which the monitoring objects 1e to 1h, for example tools, analytical apparatus, sample holders or other monitoring objects, can be located. The alignment of the detection devices 6h to 6l enables the respective position of the monitoring objects to be determined very accurately, wherein a particularly high positional accuracy can be achieved by overlapping scanning areas, as is shown by way of example in the case of the monitoring object 1h, which is located both in the scanning area of detection device 6k and in the scanning area of detection device 6l.

The scanning operations of the individual detection devices can be matched to one another with regard to their time sequence and/or their wireless frequency such that they do not mutually interfere with one another.

Two detection devices 6f and 6g are arranged in area 5d such that their sensor directions intersect, wherein each of the two sensor ranges has substantially the same surface area as area 5d. The respective sensor ranges of the detection devices are shown in the figures as dotted wave patterns by way of example. The actual extent of the sensor ranges can differ considerably from the diagram, as is clear to a person skilled in the art. With the help of position-finding techniques, such as the TOA (“Time of Arrival”) method for example, with the help of phase shifts or using angle-dependent methods, the intersecting sensor ranges allow not only the presence but also the position of the monitoring objects located in area 5d to be determined (in the case shown, the monitoring object 1d). It is also possible to use other position-finding techniques which are based, for example, on the distance, wherein the position can be measured by means of the signal run time or the signal strength, for example (examples of this include the ToA, TDoA, E-OTD, RTT or RSSI methods), on the direction, wherein the position can be measured, for example, by means of angular relationships, for example by triangulation or trilateration (such as in the AOA or DOA method for example), on the neighborhood relationships (examples of these include the CoO “Cell of Origin” method), other methods known to the person skilled in the art or on combinations of these methods.

By measuring the position, not only can the position of an individual monitoring object be determined, but a plurality of monitoring objects and their respective relative positions to one another can also be determined. Evaluating these relative positions also enables very complex groupings of monitoring objects to be detected and evaluated accordingly. Determination of the position can be extended even to a three-dimensional area by providing one or more further detection devices, for example.

Areas 5a and 5c are in each case provided with only a single detection device 6a and 6e respectively, which in each case only determine the presence of the respective monitoring objects 1a, 1b and 1c in the respective area 5a, 5c.

In an advantageous manner, not only the areas themselves, but also the transitions between areas can be monitored. In FIG. 1, the connection 14a between the areas 5a and 5b is monitored by a dedicated detection device 6b which detects when a monitoring object changes from one area to another. The detection device 6b can be arranged in a door opening between two rooms, for example, or in another place which a monitoring object must necessarily pass to get from one area to the next. Basically, a system according to the invention can be continuously monitored by scanning for monitoring objects only at the connections 14a-14e between the individual areas 5a-5e. In doing so, it is not essential for the detection devices arranged at the connections to be able to also determine the direction of movement of the detected monitoring object, as, in a closed system, it is known where each monitoring object is currently located at all times and therefore the origin of the monitoring object which is currently moving through a detection gate is known. However, the provision of redundant detection devices can reduce the susceptibility to errors and increases the reliability of the system.

In order to enable an overall picture of the monitoring objects in the plant 4 to be obtained at any time, all detection devices 6a to 6l are connected to an arithmetic unit 7 which records and stores all detection events in an inventory database 8, from which the system state of the plant 4, i.e. the monitoring objects present in the areas 5a-5e and possibly their positions, can be determined at any time. The arithmetic unit can also be used for coordinating the timing of the scanning operations carried out by the individual detection devices.

The exact design of the areas is dependent on the particular application, and the arrangement of the detection devices can be adapted specifically to suit the particular conditions of use. The configurations shown here constitute only exemplary and not restricting embodiments. Different types of detection devices and identification elements can also be used, wherein contactless and tactile systems can be used in any combination.

The evaluation of the detected monitoring objects in the arithmetic unit 7 enables a plurality of monitoring objects, which are part of a functional unit for example, to be combined to form an object group. For example, the monitoring objects 1b and 1c, which are detected by the detection device 6e in area 5c, form an object group 2a.

A further object group 2b, which is arranged in area 5b in the sensor range of detection device 6d, is shown enlarged and in more detail in FIG. 2. The object group 2b shown in FIG. 2 comprises the monitoring objects 1u, 1v, 1w and 1x, which in each case are provided with a detection element 3u, 3v, 3w and 3x, respectively. The detection elements are RFID tags which can be read contactlessly per se by the detection device 6d, an RFID sensor. However, the monitoring objects 1u, 1v, 1w and lx are arranged in a common housing 9 which is provided with its own identification element 3i. The housing 9 with the identification element 3i therefore likewise constitutes a monitoring object. The object group 2b therefore consists of the monitoring objects 1u, 1v, 1w and lx and the housing 9, which form a common unit.

As indicated by the schematically shown sensor range of the detection device 6d, the RFID signals are shielded by the housing 9. This has the consequence that, although the detection device 6d is able to read the identification element 3i attached to the outside of the housing 9, it cannot read the identification elements 3u, 3v, 3w and 3x of the monitoring objects 1u, 1v, 1w and 1x, which are enclosed in the housing.

If, for example, the object group 2b is a device to be tested which is arranged in a test environment, it would therefore be possible with a fixed detection device 6d to detect that the device (that is to say the object group 2b) were located on the test rig (that is to say, for example, the area 5b shown in FIG. 1), however it would not be possible to draw conclusions relating to the exact configuration of the measuring sensors located inside the device (that is to say the housing 9), and their identification elements are therefore shielded and cannot be read.

To solve this problem, according to the invention, the housing has a bridging device 13 which enables the detection device 6d to also read the identification elements 3u, 3v, 3w and 3x present inside the housing from the outside. In a simple embodiment, this device consists substantially of an external antenna 11 arranged on the outside of the housing, an internal antenna 10 arranged on the inside of the housing, and a gateway 12 which provides a transmission of signals between the external antenna 11 and the internal antenna 10.

In a very simple form, the gateway could be formed as a simple connecting cable between external antenna and internal antenna; however, this simple embodiment would quickly come up against technical limits.

The transmission device 13 is shown once more in more detail in FIG. 3. The external antenna 11 and the internal antenna 10 can in each case be conventional RFID antennae, which can be integrated into a label or another non-shielded housing, for example. The gateway 12 can be supplied by the energy received by the external antenna, or it can operate from its own current source, such as a battery 15, for example, or some other alternative energy source, such as a solar cell, for example, which uses the ambient lighting for generating energy. The gateway can receive and transmit RFID signals both via the external antenna 11 and the internal antenna 10. In the exemplary embodiment shown in FIG. 3, the gateway is arranged on the outside of the housing; however, it can also be provided inside the housing with the internal antenna. The internal antenna 10, and also the external antenna 11, could in each case be provided with a transponder element, wherein the two transponder elements communicate with one another and by this means form the gateway.

The gateway 12 is connected to the internal antenna by means of the connection 16. The connection can be designed as a simple cable connection which is fed via a hole. At the same time, the connection 16 can also be designed as a fixing element, by means of which the internal elements of the transmission device (in the case shown, the internal antenna 10) are connected to the external elements (in the case shown, the gateway 12 and the external antenna 11). Such connections, such as screw, plug-in, riveted or adhesive connections for example, are well known by the person skilled in the art. If necessary, the material of the housing 9 can also be used for the communication between internal antenna 10 and external antenna 11, for example by making use of the metallic conductivity of a metal housing for transmitting the data. In this case, an internal transponder connected to the internal antenna 11 and an external transponder connected to the external antenna, which together form the gateway 12, could be mounted opposite one another on the metal surface of the housing and communicate with one another across the housing wall via metal contacts. The internal and external elements of the gateway could be stuck to the housing, wherein they can also each be integrated into an adhesive label.

If the external antenna 11 is now activated by an RFID sensor signal 17a, which is emitted by the detection device 6d, the gateway 12 receives the signal and emits a corresponding signal 17b via the internal antenna 10 into the interior of the housing. The internal signal 17b can therefore be received by an RFID tag (e.g., the identification element 3u) inside the housing, as a result of which the identification element 3u is activated and outputs a response signal 17c which, in turn, can be received by the internal antenna 10. The response signal 17c of the RFID tag is processed in the reverse direction by the gateway 12 and emitted as a corresponding response signal 17d via the external antenna 11, thus enabling it to be received by the detection device 6d.

To avoid interference, the signals 17b and 17c can use a different frequency internally from that of the signals 17a and 17b processed by the detection device 6d. In conjunction with multiband RFID systems, this enables very complex and functionally stable systems to be created.

The gateway serves as a “hub” between the interior of a device, typically therefore inside a metal housing, and the exterior, typically the test rig cell in which the device is located. This enables communication between a read station (fixed to the test rig, that is to say mounted externally) and an RFID tag fixed to a component (located inside the housing). As the metallic housing of the device acts as a Faraday cage and shields HF fields, this communication would not normally be possible, that is to say without bridging device.

For RFID tags which are mounted directly on metal surfaces or which are to be read in a metal-rich environment, it is possible to use special RFID tags which are designed for this purpose. Such RFID tags are known to the person skilled in the art and they normally use special antenna arrangements which are less affected by the disturbing effects of the metallic environment.

The steps of a method, which can be carried out with the help of the described devices, are now described below by way of example. The method serves to map the inventory of monitoring objects, which are located in a plant, in a database and to keep this map up to date, preferably in real time.

With reference to the example shown in FIGS. 1 to 3, the unique identifiers of the identification elements (3a-3x) present in the areas (5a-5e) are read by means of the detection devices (6a-6l) assigned to the areas, if necessary using appropriate gateways 12. Alternatively and/or in addition, starting from a previously initialized starting status, all movements of detection elements between the areas (5a-5e) and across appropriately defined system boundaries are recorded in order to track the operating state of the plant. In areas which support position determination, movements within the area can also be recorded.

The identifiers read by the detection devices are evaluated by the arithmetic unit 7 to which the detection devices are connected, wherein, in each case, the particular monitoring objects to which the identifier read from the identification element is assigned is determined. The data relating to the particular monitoring object are then determined from the database 8, and the database is updated based on the detection event should updating be necessary. Updating is necessary in particular when the location of the monitoring object has changed, when the state of the monitoring object has changed, or when the monitoring object is added to an object group or removed therefrom. In order to determine whether the state of a monitoring object has changed, other data can also be taken into account, for example data which are derived from the sequences of operations that have been implemented. In this way, for example, the wear of a monitoring object can be determined based on the period of use. Maintenance and calibration intervals, for example, can also be determined in this way and warnings automatically output as soon as maintenance, calibration or replacement of a monitoring object has to be carried out.

Certain monitoring objects can be defined in the database as object groups. If a monitoring object which is assigned to an object group is now scanned, the method can carry out a check as to whether all other monitoring objects which are assigned to this object group are also present. If this is not the case, the system can output a warning, for example, or initiate a different workflow which has previously been defined for this case.

In other cases, the system can draw conclusions concerning the whole object group from the detection of a single monitoring object. If, for example, a change of location of individual monitoring objects or object groups is detected, the method can also change the location of all other monitoring objects of the same group. This can be expedient when the object group is permanently assembled and can only be moved together, and/or when there is a probability that some monitoring objects in a group cannot be detected due to shielding operations. Such a conclusion is permissible particularly when none of the monitoring objects of the group is simultaneously detected in a different area.

On the other hand, when a change in location of an individual monitoring object of an object group is detected, the conclusion could be drawn that an element of the object group has been removed from the group and the group is therefore no longer complete. This is the case particularly when other monitoring objects of the same group are detected in a different area at the same time.

In all cases, the detection of a certain event can lead to a warning being output or some different, previously defined workflow can be initiated.

The identification elements can be read on a timed basis, for example at certain intervals, and/or initiated on the occurrence of a certain event, for example when the status of the plant is requested during the scheduling of resources, or when an identification element is moved through a certain area (e.g., an RFID gate).

Furthermore, the method can provide steps for checking the integrity of monitoring objects and/or object groups. An integrity check can be carried out automatically, for example by scanning all identification elements of the group in the same area, wherein the spatial arrangement of the monitoring objects can also be checked as long as the system is equipped with appropriate position-finding techniques. If necessary, operator intervention may also be necessary to check the integrity. To this end, the system can output an alarm, for example, and request the user to take the necessary steps and to then rectify the matter. The database can then be supplemented/modified based on the confirmation. The integrity check can also include monitoring of the maintenance and/or replacement intervals of individual monitoring objects in an object group.

As, in this way, the inventory and state of the monitoring objects in a plant in the database is always kept up to date, it can be checked at any time whether a planned activity on the plant can be carried out with the monitoring objects or object groups present in the plant. This simplifies resource planning and also enables anticipatory planning of future deployment in distributed organizational structures. A team that takes over a plant, for example to implement a particular test sequence, can immediately check whether a previously defined operating state of the plant has been established. This considerably simplifies the handover from one team to the next. If necessary, automatic warnings can be output when the operating state differs from the planning state.

In an advantageous manner, monitoring of the maintenance state of the plant or individual parts thereof can also be realized by third-party providers with the system according to the invention, wherein the data which are to be transmitted to this service provider or which can be accessed by him, and which cannot, can be accurately controlled. In this way, for example, the data which serve to localize the monitoring objects remain locally with the proprietor or user of the plant, and only consistency data are passed on to the service provider. This considerably simplifies the planning of maintenance operations for the service provider, as he can make use of the relevant data at any time, and, in spite of this, the proprietor or user of the plant has the security that sensitive data, such as the structure of experimental and test systems for example, do not get into the hands of third parties.

The consistency data can also be used to detect possible fake products which are used in a system. Original products can be detected based on the serial number associated with the identification element, for example. Merely the fact that an object is provided with an identification element enables a conclusion to be drawn as to whether it is an original object. In order to detect fake identification elements, an encrypted code, the encryption of which can only be decrypted by the service provider or the producer of the original component, can also be stored on the identification element.

1. A system for recording an inventory of monitoring objects of a plant having a multiplicity of fixed or non-fixed areas where monitoring objects can be located, wherein the plant is suitable for carrying out sequences of operations using the monitoring objects, wherein the plant has a multiplicity of detection devices which are each assigned to an area of the plant, and the monitoring objects are in each case provided with preferably contactlessly readable identification elements which have a unique identifier, wherein the detection devices have a data connection to an arithmetic unit which manages an inventory database.

2. The system according to claim 1, wherein the plant has at least one detection device or a group of detection devices which is/are suitable for determining position.

3. The system according to claim 1, wherein the system has a multiplicity of object groups which can comprise one or more monitoring objects.

4. The system according to claim 1, wherein the arithmetic unit has means for checking whether a given sequence of operations of the plant can be implemented with the existing monitoring objects or object groups.

5. The system according to claim 1, wherein the plant is part of an intelligent manufacturing line and the sequence of operations is a production process.

6. The system according to claim 1, wherein the plant is part of a test environment and the sequence of operations is the implementation of a test, an experiment and/or a measuring process,

7. The system according to claim 3, wherein the system comprises a bridging device for a housing of an object group, which has a plurality of monitoring objects, wherein the housing has a shielding effect, wherein the bridging device has an internal antenna, an external antenna and a gateway, which enable identification elements arranged in the housing to be detected via the external antenna.

8. A method for mapping an inventory of monitoring objects of a plant in an inventory database, wherein the plant has a multiplicity of detection devices which are each associated with an area of the plant, and wherein the monitoring objects have identifying elements which can be read, preferably contactlessly, by the detection devices, wherein the method has the following steps:
reading out by means of a detection device assigned to an area of at least one unique identifier from at least one contactlessly readable identification element which is present in the appropriate area,
determination of a particular monitoring object to which the identifier read from the identification element is assigned,
determination of data which relate to the monitoring object,
storage or updating of the data in the inventory database.

9. The method according to claim 8, wherein the method also has the following steps:
determination of an object group to which a particular monitoring object is assigned,
determination of data which relate to the object group, and
storage or updating of the data in the inventory database.

10. The method according to claim 8, wherein the read-out is initiated at controlled intervals and/or on the occurrence of an event.

11. The method according to claim 8, wherein the method also has the step of checking the integrity of a monitoring object and/or an object group,

12. The method according to claim 8, wherein it is checked whether a planned activity with the plant can be carried out with the monitoring objects or object groups present in the plant and, if necessary, a warning is output.

13. The method according to claim 8, wherein data from the database are transmitted to a service provider remote from the plant.

14. A bridging device for a housing of an object group, which has a plurality of monitoring objects, which are each provided with contactlessly readable identification elements which have a unique identifier, wherein the housings has a shielding effect, wherein the bridging device has an internal antenna, an extern& antenna and a gateway, which enable identification elements arranged in the housing to be detected via the external antenna.
